(19) United States
(12) Patent Application Publication
(10) Pub. No.: US 2021/0259453 A1
(43) Pub. Date: Aug. 26, 2021

(54) COOKING DEVICE AND SYSTEM

(71) Applicant: RJ BRANDS, LLC, Mahwah, NJ (US)

(72) Inventors: Ralph Newhouse, Monsey, NY (US); Harold Brooks, Hollis, NY (US); Rene Midouin, Monticello, NY (US)

(73) Assignee: RJ BRANDS, LLC, Mahwah, NJ (US)

(21) Appl. No.: 17/184,545

(22) Filed: Feb. 24, 2021

Related U.S. Application Data
(60) Provisional application No. 62/981,517, filed on Feb. 25, 2020.

(51) Int. Cl. A47J 27/08; F24C 7/08; A47J 27/082; A47J 27/086; A47J 27/092; A47J 36/32; A47J 36/16

(52) U.S. Cl. CPC A47J 27/0802; F24C 7/086; F24C 7/08; A47J 27/082; F24C 15/006; A47J 27/092; A47J 36/321; A47J 36/16; A47J 27/0815; A47J 27/086

(57) ABSTRACT

An apparatus and method for computer controlled cooking devices is provided. The cooking apparatus may include an outer housing, an inner lining, a housing cavity, an insert, a controller, a heating element, and a user interface. The base may include a plurality of feet. The plurality of feet may comprise a plurality of pressure sensors. The controller may be configured to receive input signals corresponding to electrical communications from a plurality of pressure sensors. The user interface may include a display and the display may present an image corresponding to a pressure sensed by the plurality of pressure sensors.

### TECHNICAL FIELD OF THE INVENTION

The invention is related generally to the field of cooking and computerized cooking devices. More particularly, the invention relates to apparatuses, methods, and systems for computerized cooking in conjunction with one or more sensors.

### BACKGROUND

There are a number of internet connected cooking devices on the market. Many cooking devices are further sold with accompanying recipe books. However, a problem remains that when attempting to accurately reproduce recipes, users must shop for their own ingredients, which may not be the same as what is called for in the recipe, and attempt to follow the recipe that was likely cooked on different equipment and under different conditions that the user will be operating under. General recipes also do not provide that ability to provide feedback to the user during the cooking process, nor do they provide specific instructions on how to perform the steps of the recipe. Searching for recipes to fit a person's particular dietary needs and tastes is also time consuming as the user must sift through incompatible recipes (often painstakingly analyzing each ingredient in case one conflicts with a dietary restriction) before finding a recipe that may be worthwhile. Manually searching recipes also leads to decision fatigue resulting in users repeatedly making a small select set of known recipes.

While some cooking devices may be connected to the internet, there is still a problem with coordinating the operation of the cooking devices and adjusting the devices to account for environmental differences between the originator of a recipe and the user attempting to recreate the recipe at home. Further, many recipes merely provide approximate values for ingredients (e.g. one onion, two peppers, etc.) without accounting for the differences in size and mass that ingredients may exhibit. And even when a recipe provides a weight measurement for an ingredient, the recipe may not provide the user with a reliable way to scale the recipe as cooking times and temperatures are highly dependent on the particular size and proportions of ingredients and there is not necessarily a linear relationship among such cooking factors. The present cooking device and system overcomes the forgoing problems and others and enables users to accurately and reliably recreate recipes and scale recipes.

### SUMMARY

The present system relates to computer controlled cooking devices as well as a support network separate from the cooking device that allows for a user to accurately recreate recipes. More particularly, the system utilizes one or more cooking devices that each include an integrated computer controller that controls a multitude of cooking operations of the associated device, a user application operating on a separate user computer (such as a laptop, desktop, smart phone or other mobile device, tablet, etc.,), a cloud based network that may house user profiles and a collection of stored recipes and instructions that are stored remotely from the cooking device and the user computer (but which may be downloaded onto either the cooking device or the user computer), and a content creator, or test kitchen, that develops recipes and instructions using the particular model cooking devices that are the same as user's cooking devices or empirically tested to determine their operation is equitable to a model(s) of cooking device(s) that a user may own.

Prior to storing a particular recipe on the cloud, the content creator develops recipes and records the particular weights of the ingredients utilized. The recipes are made utilizing one or more specific models of cooking devices, which are then associated with the recipes. The recipes are recreated multiple times to empirically determine the desired ratios of ingredients and cooking times and settings depending on the ratios of ingredients. In that way, a single recipe may include a plurality of alternative preparations, each alternative based on the modification of the ratios of the ingredients or alternate desired outcomes. The recipe, with alternative preparations, is stored on the cloud, such as on a network server. Users access the cloud via an app on the user computer that syncs with a user profile on the cloud and the recipes.

The user may then prepare the recipe in conjunction with a cooking device corresponding to the recipe. The cooking device is connected to the network and may include an integrated scale. The user follows the recipe by adding the identified weights of ingredients to the cooking device. The cooking device automatically weighs the ingredients as they are added and may display the weights on a display of the cooking device and also transmit the weights to the user device though the online network. The network or user device may then match the weights with the ingredients being added and the user device may continue to guide the user through the cooking process. The user device, network, and cooking devices may further coordinate the cooking process such that the operation of the cooking devices may be synced to cook ingredients, for example, according to a desired schedule by setting one cooking device which then coordinates cooking among multiple cooking devices.

Additional embodiments and operations of the cooking device and system are discussed in further detail in connection with the figures.

### BRIEF DESCRIPTION OF DRAWINGS

FIG. 1 is a perspective view of one example of an embodiment of a cooking device.

FIG. 2 is an exploded view of one example of the housing and interior of an embodiment of a cooking device.

FIG. 3 is an exploded view of one example of an insert and lid of an embodiment of a cooking device.

FIG. 4 is an exploded view of one example of a controller, display, and user interface of an embodiment of a cooking device.

FIG. 5 is an exploded view of one example of a base of an embodiment of a cooking device.

FIG. 6 is an exploded view of one example of an actuator and system of releasing pressure in an embodiment of a cooking device.

FIG. 7 is a block diagram of one example of a controller and associated components of an embodiment of a cooking device.

FIG. 8 is a flowchart describing a method of operation of a cooking system implementing one example of an embodiment of a cooking device.

FIG. 9 is a block diagram of the operation and relationship of an embodiment of a cooking system.

FIG. 10 is an example of a lookup table of empirically determined data for particular recipes and cooking device models.

FIG. 11 is a flow chart of the coordinated operation of one example of and embodiment of a cooking device, user computer and app, and cloud network.

FIG. 12 is a flow chart of an exemplary option for selecting cooking parameters through one example of an embodiment of a cooking device.

FIG. 13 is an example of data storage for a calculator search, which may be stored as super trees and subtrees.

FIG. 14 is an example of data storage for a calculator search, which may be stored as super trees and subtrees.

FIG. 15 is an example of data storage for a calculator search, which may be stored as super trees and subtrees.

FIG. 16 is an example of a super tree subdivided into subtrees.

FIG. 17 is an example of a smart bar displaying various options based on the cooking method selected.

FIGS. 18A-B is an example of one or more user computers executing one or more active recipes.

FIG. 19 is an example of a network including a cooking device in wireless communication with one or more user devices.

### DETAILED DESCRIPTION OF EMBODIMENTS

Throughout the specification, wherever practicable, like structures will be identified by like reference numbers. In some figures, components, such as additional electrical connections or fasteners have been omitted for clarity in the drawings. Unless expressly stated otherwise, the term “or” means “either or both” such that “A or B” includes A alone, B alone, and both A and B together.

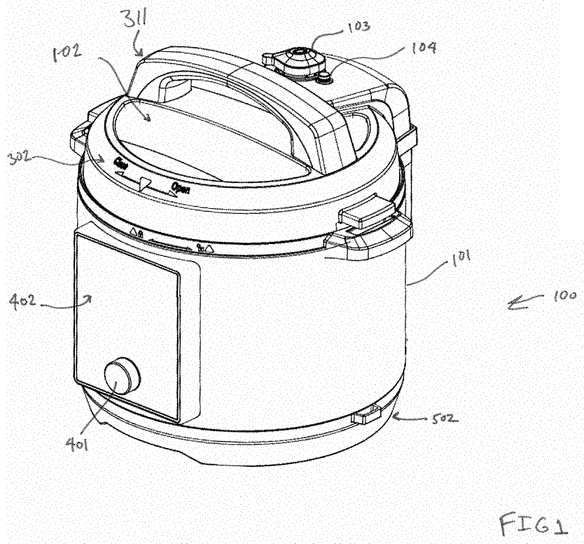

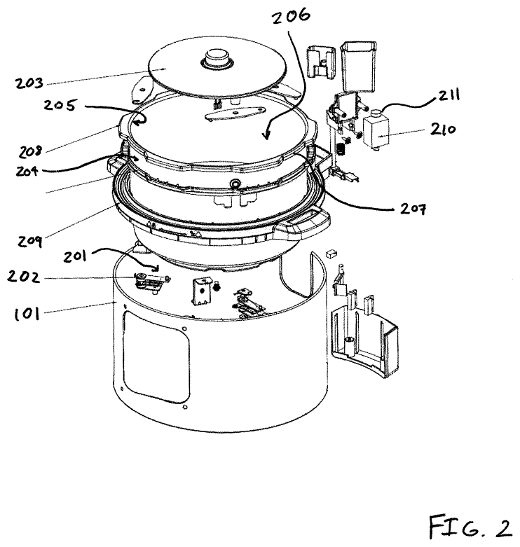

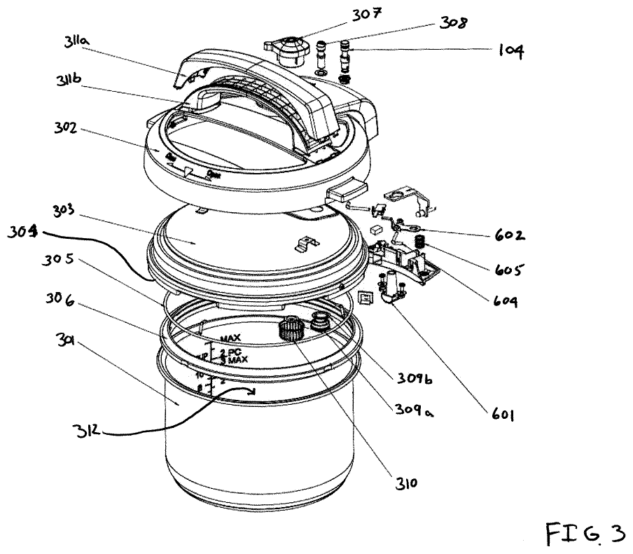

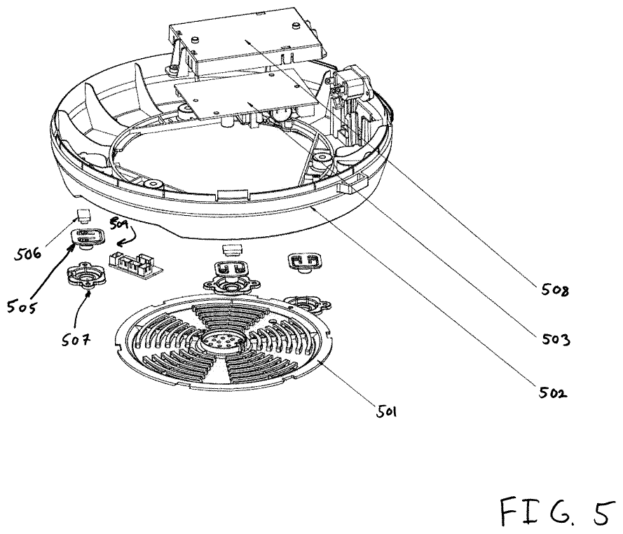

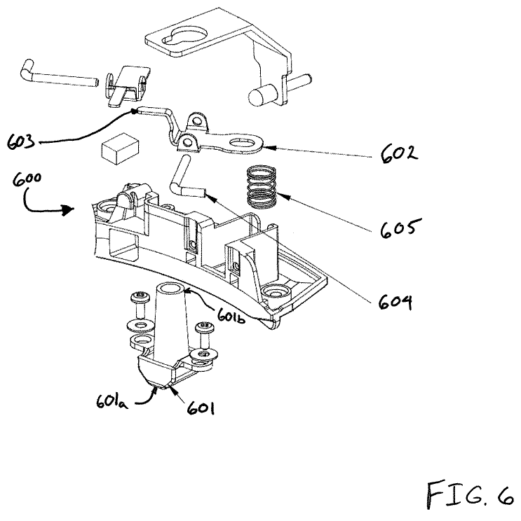

Referring to FIGS. 1-6, one example of a cooking device that could be used with the present system is multicooker 100. The multicooker may operate in a plurality of different modes including warming, slow cooking low, slow cooking high, sauté, sear, pressure cook, sterilization, and others. The multicooker includes an outer housing 101 having a sub-cavity 201 that is adapted to accommodate an inner lining 204. The inner lining 204 defines an annular wall 205 which forms the lining cavity 206 and terminates in an annular flange 207, which may include a plurality of protrusions 208, at the top of the cavity 206. The inner lining 204 may be mounted to a structural ring 209 which in turn is mounted to the outer housing 101. The structural ring surrounds the inner lining and secures to the outer housing to provide structural support to the outer housing and to separate the outer housing from the inner lining thereby forming sub-cavity 201. At the bottom of the cavity 206 is a sensor 202, such as a pressure switch, that senses the presence or absence of a cooking vessel 301, such as a pot, defining a cooking cavity 312 and heat transfer device 203, such as a thermoelectric hotplate. In an embodiment, the pressure switch may be a binary sensor (detecting sufficient pressure or lack of pressure) or may detect a spectrum of pressures (for example, quantifying the pressure on the switch during a particular instance). In such an embodiment, the pressure switch may have a predetermined sufficient pressure or pressure threshold.

The multicooker includes a lid 102 that may lock with the inner lining. For example, the lid includes an outer shield 302 that covers and is fixed to an inner lid 303 having a plurality of protrusions 304. The lid is adapted to releasably engage the annular flange 207 by mating protrusions 304 and protrusions 208 such that when engaged the lid is prevented from being removed from the housing without first rotating the lid with respect to the inner lining 204. The lid may also include a gasket retention bar 305 and a gasket 306, such as a silicone ring.

The lid includes a valve 103 that may be adjusted, such as by rotating the valve, to open and close a passage between the interior of the pot inside the cavity 206 and the environment. The valve may be closed to seal off the interior of the pot inside the cavity 206 when the lid is engaged with the annular flange 207g. For example, the valve may include a movable valve top 307 that mates with a valve stem 308. The valve top fits over the exterior end of the valve stem, and a gasket assembly 309a, 309b fits over the interior end of the valve stem while a vented cover 310 fits over the gasket assembly to block food matter from clogging the valve stem when steam or pressure is released from the cooking cavity 312. In an embodiment, the valve stem includes a valve stem sensor that may detect when the valve stem is clogged. The lid may also include a sensor that senses pressure within the cooking cavity and provides an indication that the multicooker is pressurized. In an embodiment, the sensor may incorporate error determination. For example, the sensor may be configured to alert the computer or controller when the multicooker is over-pressurized. In such an example, the multicooker may be instructed to decrease the pressure to a safe or acceptable level. One sensor is a plunger 104, or floating valve, that alters its position with respect to the lid when the pressure inside the cooking cavity sufficiently builds. The sensor may be a different color from the color of the lid or provide another visually distinctive appearance with respect to the lid or light up when the housing is pressurized. The lid may further include a handle 311 (which may be composed of one or more pieces 311a, 311b).

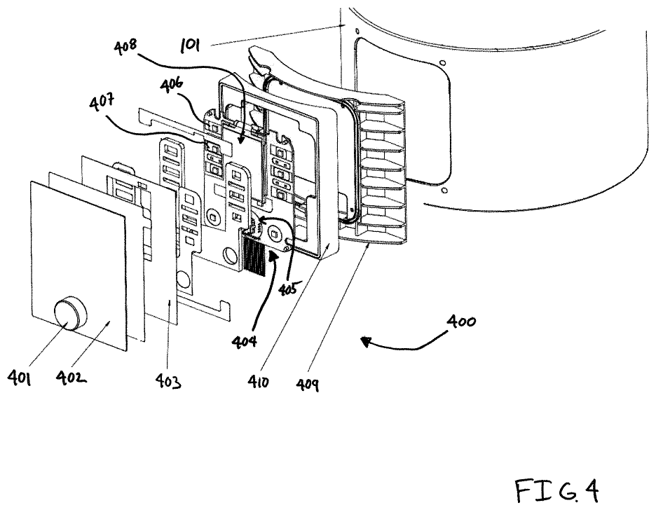

The housing includes a controller, such as a computer, that operates the various functions of the multicooker, a user interface, which may be a touch screen, buttons, knobs, or a combination thereof, and may also include a lid sensor, an actuator or both. In one embodiment, the computer is integrated with the touchscreen user interface and is thus located between the inner side wall and the external surface of the user interface. For example, as shown in FIG. 4, the controller 400 may include a user interface (for example, control knob 401 and an exterior touchscreen 402), a diffuser 403, and a PCB 404 having a processor 405, input sensors, 406, 407, and a display 408. The integrated embodiment allows for the computer to be positioned within a sub-cavity 201 within the outer housing between the touch screen and the inner lining 204. The computer may be mounted to mount 409 which is affixed to the interior of the outer housing, and the computer may further be surrounded by a protective covering 410. Such arrangement allows for the computer to be mounted on the side of the multicooker, but still be sufficiently surrounded by airflow such that the heating of the pot 301 and ingredients within the cooking cavity 312 does not overheat the computer. By providing a sub-cavity between the inner lining and the housing that is exposed to the environment via the grate 501 mounted in the base 502, and which surrounds (or substantially surrounds) the exterior of the inner lining 204, airflow is created within the sub-cavity 201 to cool the controller 400, power supply 503 and other electrical components. The power supply may be mounted to a bracket 508 that may be mounted to the bottom of the inner lining 204 or alternatively to the inside of the housing 101.

In one embodiment, the controller 400 is removable from the housing. In such an embodiment, the backside of the controller 400 may have one or more signal outputs that interface with one or more signal inputs on the housing. The controller 400 may also include an internal battery. In one embodiment, the controller 400 may still be in electronic communication (for example, a wireless connection) with the multicooker or components of the multicooker when removed from the housing. In another embodiment, the controller 400, touch screen 402, video display 408, and/or user interface, may be configured to allow a user to access information while the controller 400 is removed from the housing. In an alternate embodiment, the controller 400 is configured to physically or wirelessly interface with other devices. In such an alternate embodiment, the user may utilize the controller 400 to control other devices.

In one embodiment the user interface is a combination of a touchscreen and a dial (or knob) that may also be a button. The dial is affixed to a post that is connected to an interface that communicates with the computer. Thus by rotating the dial, signals are sent to the computer to control the user interface. Similarly, depressing the dial sends a signal to the controller, for example, indicating a selection. In an alternate embodiment, the dial may be depressed and/or pulled away from the interface, both actions sending a signal.

The touch screen 402 may display various selection options, such as the type of cooking to be used, a scale selection, and a valve release. The center portion of touch screen 402 may include a video display 408 that includes GUI that may display an assortment of menus, recipes, videos of the cooking process or instructions, and may provide feedback from the scale. As non-limiting examples, the touch screen 402 and/or video display 408 may be LED, LCD, or “E-Ink” screens. The user may cycle through the menus using the dial and make selections using the dial or touchscreen.

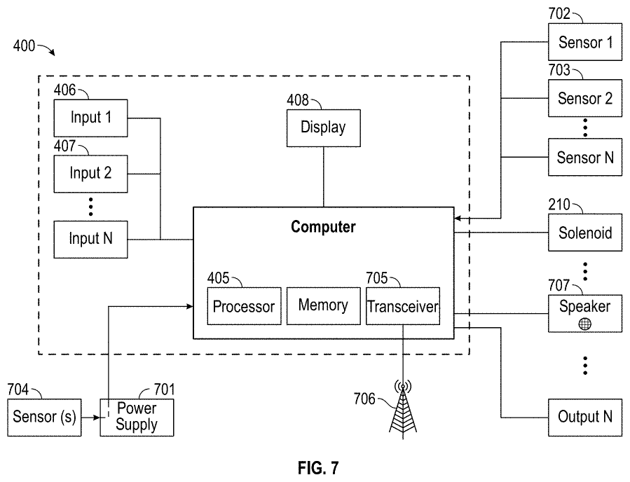

FIG. 7 depicts a block diagram of an embodiment of an electrical system including the controller and power supply 701. The various components are depicted as being separate from the computer PCB, but it should be understood that alternate embodiments may integrate one or more of the components shown with the computer PCB. The computer is connected to inputs 406, 407 through input N and may be connected to sensors 702, 703, through sensor N. Additionally or alternatively sensors such as sensor(s) 704 may be connected to the power supply board 701 and routed through the power supply board to the computer. The computer is connected to a transceiver 705 which may also include an antennae 706. The computer may include outputs such as display 408, speaker 707, solenoid 210, through output N. In another embodiment, the computer may have one or more power outputs in electrical communication with the power supply 701. In such an embodiment, one or more auxiliary devices may receive power from the one or more power outputs. In an alternate embodiment, the power supply 701 is a battery (for example, a rechargeable battery).

In an embodiment, the lid 102, with the valve 103 closed, may be engaged with the inner lining 204 and thus the housing 101 and the computer may be set to pressure cook. The computer sends a signal to the thermoelectric plate to heat, and the heat is transferred to the pot which transfers the heat to the material (such as food) in the pot causing the material to expand and build pressure in the cooking cavity. Upon satisfying an event criteria, such as the expiration of a timer, the computer automatically releases the pressure. The computer transmits a signal to a solenoid 210 to activate. The solenoid moves the plunger 211 and thereby moves the linkage 600 in the lid which in turn releases the valve and thus releases the pressure in the cooking cavity. In one embodiment, the linkage includes a contact piston 601 that has a proximal end 601a associated with the plunger 211 and a distal end 601b associated with a pivot arm 602. The pivot arm includes a finger 603 that is resiliently biased in the down position by a spring 605, and the pivot arm is pivots about the axis of an axel pin 604. The when the piston 601 is raised by the plunger 211, it causes the pivot arm 602 to rotate and thereby raise the finger 603. The finger contacts the valve top 307, forcing the valve top to move and open the valve to release the pressure.

In an embodiment, the computer provides a warning, such as an audio or visual cue, such as a countdown that may include beeps that progress in frequency prior to the actuation of the solenoid. In one embodiment, the user interface of the pressure cooker may provide an audio response when a selection is made. Alternately, the audio response may be set to silent. In a further embodiment, the pressure cooker, or a component of the pressure cooker, may vibrate when emitting a warning and/or confirming a selection. Alternatively, the warning and/or selection confirmation may emit, solely or in conjunction, from a separate user computer (such as a laptop, desktop, smart phone or other mobile device, tablet, etc.,).

In one embodiment, when the automatic valve release is activated, the computer will, prior to releasing the valve, override the silent setting and provide an audio alert. In one embodiment, the cooking device is provided with an additional sensor or sensors, such as a microphone or an optical sensor that detects changes in light. In one embodiment, the microphone may be configured to receive audio instruction from the user. In one embodiment, the optical sensor may be configured to detect whether the food item, ingredients, lid, or other component of the device are properly placed and configured. For example, the optical sensor may detect the presence of an object when the object is encroaching on the vent. The sensor may detect when an object is located proximal to the vent. In one embodiment, one or more sensors may be disposed such that the one or more sensors detect the location of a user. In such an embodiment, the sensor may send a signal to the controller, enabling a particular function of the device. For example, the sensor may detect when a user is proximate to the cooking device, sending a signal to the controller to pre-heat the heating element. In another embodiment, the cooking device may utilize the coordinates of the user's device in enabling an action of the cooking device (for example, pressurizing the cooking device when the user's device is located proximately to the kitchen). The sensor may send a signal to the computer that causes the computer to prevent activation of the automatic valve release function. When the sensor senses that the object has moved sufficiently away from the vent, it sends a signal to the computer and the computer allows the automatic valve release function to operate. It should be understood that the sensor(s) may continually or intermittently transmit data to the computer and the computer may process those signals to determine the presence or absence of an object. In an embodiment, there is a pre-determined distance that the object may be from the vent before the automatic valve release function may operate. For example, the pre-determined distance may be two inches. In such an example, the sensor sends a signal to computer when the object is at least two inches from the vent. However, in alternate embodiments, any distance maybe utilized. Further, in another embodiment, the sensor may detect the size, weight, or density of the object and factor those characteristics into whether the automatic valve release function should operate. The user interface may also include a sensor override, such that when the computer determines that an object it too close to the vent, it prevents the release of pressure, but the user can select to override the computer and allow the computer to release pressure anyway. The user interface may provide a warning to the user that an object is too close to the vent and that releasing the pressure could cause damage to the object.

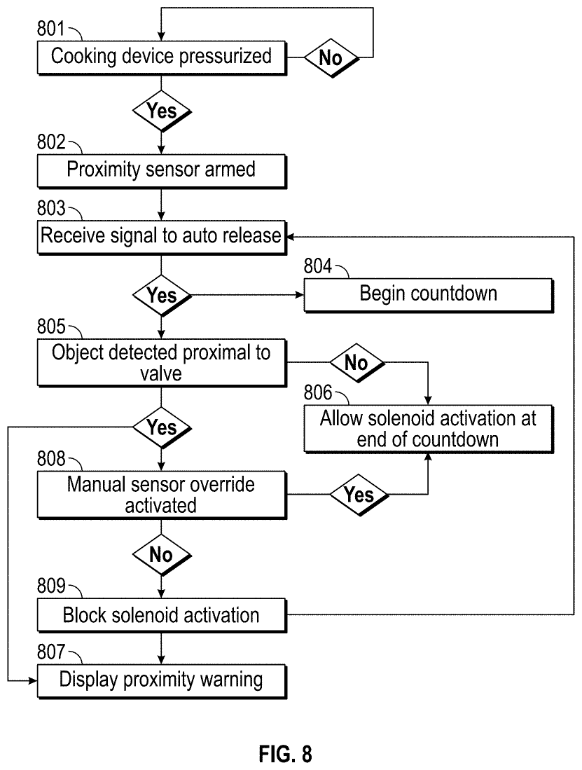

One example of a routine followed by the computer in performing the automatic valve release function is shown in FIG. 8. The computer checks if the cooking device is pressurized 801. If it is, it arms the proximity sensor and monitors for signals from the proximity sensor 802. In an embodiment, the computer may check exclusively for signals from the proximity sensor. In another embodiment, the computer monitors for more than one signal. In such an embodiment, the computer may contain instructions on how to sort signals based on their origination, frequency, strength, or the type of information being transmitted. Further, in such an embodiment, the computer may differentiate between signals. The computer waits for a predetermined event, such as the expiration of a timer at which point it receives a signal to perform an auto release 803. The computer begins the countdown 804 and checks for a signal from the proximity sensor 805. If no proximity signal is received, at the expiration of the timer the computer activates the solenoid to automatically release the pressure 806. In an embodiment, the pressure may be released at a predetermined rate (for example, 1 psi per 5 seconds). However, in various embodiments, the pressure may be released at any rate. In one embodiment, the rate of pressure release may be a function of the pressure (or other characteristic) of the pressure cooker. For example, if the cooking device is under a very high pressure, the rate of pressure release may be lowered. Further, if the cooking device is exceptionally hot, the rate of pressure release may be decreased. In an embodiment, the controller or computer may contain an algorithm, which determines the pressure release rate relative to environmental or internal parameters. If a proximity signal is detected, the computer may display/emit a proximity warning 807, and the computer checks for whether the manual override has been activated. If the manual override is detected, the computer activates the solenoid and automatically releases the pressure 806. If the manual override is not detected, the computer blocks the activation of the solenoid 809, may display/emit a proximity warning 807, and returns to check for an auto release signal.

The user interface may also display an option for the user to select to release the pressure. Thus, the user may select “pressure release” on user interface that is positioned on an external sidewall of the housing, away from the location of the valve, and the computer will actuate the solenoid to release the pressure. That allows the user to release the pressure without touching or placing the user's body near the valve where hot steam escapes during a pressure release. In an embodiment, there is a non-mandatory, but recommended pressure release, enabling the user to use discretion in releasing the pressure. Such a recommended pressure release may be manifested as an option or prompt on the display.

The multicooker may further include integrated sensors. For example, the multicooker may include one or more sensors that sense the weight of objects placed within the cavity. The sensors are connected to the user interface. When an object is placed within the cavity, the sensors transmit a signal to the computer and the computer sends instructions to the display to display information relating to the weight of the object. For example, the display may present a readout of the sensed weight in numerals with associated units. Alternatively, the display may change in appearance, such as by presenting a graphical depiction of the weight. In an embodiment where the weight sensor is within the cavity, the weight sensor may take into account force differences as a result of liquids being present in the cavity. As a non-limiting example, if the cavity is filled with 1 liter of water and 1 large onion, the computer may receive a signal from the weight sensor, and subtract the weight of 1 liter of water to determine the weight of the 1 large onion. Further, this process may be extrapolated to determine the weight of one or more items within any number of fluids. In another embodiment, the weight sensor and computer may take into account the buoyant force of an item when determining the item's weight.

In one embodiment, the multicooker is provided with four sensor feet. However, in alternate embodiments the multicooker is provided with any number of sensor feet. Each foot 504 includes a sensor, such as pressure plate 505 and transducer 506. The sensors may transmit signals to the computer that are indicative of a sensed pressure. The feet are arranged and affixed to the bottom of the housing. In one embodiment, each foot includes a sensor and a removable cover 507 that holds the sensor in place. The cover may be fastened to the housing by fasteners such as screws. This allows the sensors to be easily removed and replaced if damaged.

The bottom of the housing is further provided with a grate 501. The grate allows for airflow to occur between the environment and a sub-cavity 201 within the housing. The sub-cavity is formed between the inner lining 204 and the housing 101. The sub-cavity houses the electrical components of the multicooker, such as the power supply 503 (which is connected to an external cord and plug for connection to a standard wall electrical socket) and the computer. The airflow may be quantified as the volume of air that passes the cross-sectional area of the grate. In such an embodiment, a sensor may be disposed along the grate to capture a portion of airflow to determine its speed and/or airflow rate.

Embodiments may also include additional sensors, such as a microphone or a photoreceptor that may sense and identify objects oriented proximal to the device. In an embodiment, the actuator is connected to the computer. In an embodiment the actuator is a solenoid plunger. The plunger aligns with a linkage inside the lid when the lid is engaged with the housing. The linkage is further connected to the lid valve.

In one embodiment, the cooking device may be equipped with an electronic tongue. The electronic tongue may be comprised of one or more sensors configured to respond to a particular taste. The electronic tongue or its one or more sensors may be used in conjunction with pattern-recognition software. The electronic tongue may be configured to mimic the tasting capabilities of a human tongue. In one embodiment, the electronic tongue may include electrode sensors capable of detecting dissolved compounds. In a further embodiment, each electrode sensor may be configured to detect a different compound. The electronic tongue may be in communication with the memory and processor 405. The memory may contain instructions or a database correlating the prevalence of certain compounds to a taste (for example, presence of fructose correlating to a sweet taste). Thus, the information provided by each of the sensors, in conjunction with the compound-taste database, may allow the cooking device to “taste” the food as it is cooking. In such an embodiment, the cooking device may be configured to modify a recipe in order to match a preferred taste pattern. As a non-limiting example, if the user prefers sweet foods and the electronic tongue is detecting only mild levels of fructose, the cooking device may alert the user to add more table sugar to the ingredients.

In an embodiment, the multicooker includes one or more cameras. In such an embodiment, the one or more cameras may be disposed within the housing such that the one or more cameras face the ingredients. The one or more cameras may be in communication (wired or wireless connection) with the controller 400. The memory may contain image-recognition software and/or a database of images of foods. The camera(s) may further be in communication with the memory and/or processor 405. In such an embodiment, the images captured by the camera(s) may be analyzed via image-recognition software to determine the state of the ingredients during a cooking session. As a non-limiting example, the camera(s) may capture an image of a steak as it is being cooked and the image-recognition software may enable the controller 400 to stop cooking the steak once it has reached a hue of pink that corresponds to medium rare. In another embodiment, the images from the camera(s) may be displayed on the video display 408 or stored on the memory (where they can later be retrieved on the user computer or cloud network).

The cooking devices may further be equipped with wireless communication components, such as one or more wi-fi or Bluetooth receivers and transmitters (which may be separate or integrated) such as, in multicooker 100 transceiver 705. The cooking devices are programed to transmit and receive various messages including an identification of the type of cooking device. The messages may be received by a user computer and the user computer and cooking device may connect to one another to transmit data and instructions. In one embodiment, information regarding the operation of a first cooking device is transmitted by that device, for example via wi-fi connection or Bluetooth, to the user computer. Information regarding a second cooking device may likewise be transmitted from the second device to the user computer. The user computer receives the data and compiles it with the recipe being followed by the user device. The user device may then transmit instructions to one or more of the cooking devices to coordinate cooking among the devices in accordance with the recipe or additional instructions provided by the user (for example the desired completion time). For example, the user device may decrease the temperature in an oven, turn on a convection fan, change a high heat slow cooker to a lower temperature, send other set a toaster oven to broil, or send other instructions to one or more other cooking devices.

In one embodiment, the cooking devices may connect directly with other cooking devices. For example, a multicooker or slow-cooker can connect to an oven. The two devices may exchange data regarding the operation of the other to coordinate cooking between them. For example, a cooking device may utilize a Bluetooth connection to connect with an accessory product, such as a thermometer. The thermometer may transmit data through the Bluetooth connection to the cooking device, which may in turn utilize that input data to control its operation. In one embodiment, the cooking device may include a meat thermometer or a probe thermometer (for example, disposed such that the meat or probe thermometer may read the internal pressure of a food as it is cooking). In an alternate embodiment, the cooking device may include a temperature gun (for example, an infrared temperature gun) that may read the surface or internal temperature of a food item or the air temperature within the cooking device.

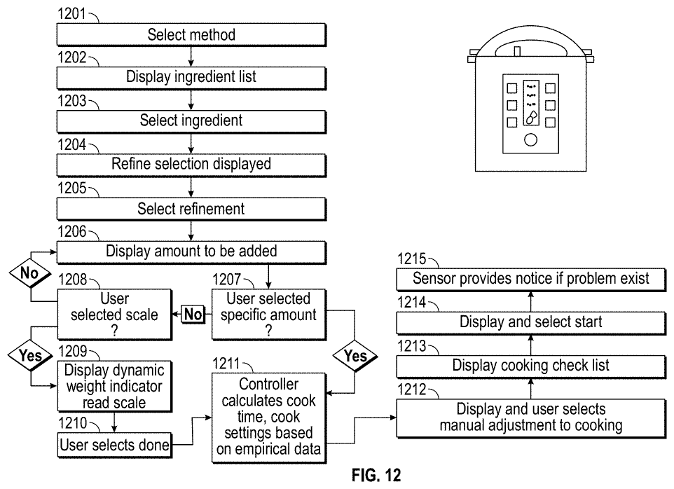

In one embodiment, the cooking device may be operated through the inputs for the controller 400 to cook with or without a recipe. For cooking without a recipe, the cooking device has stored in memory a number of cooking outcomes based on available cooing options. With reference to FIG. 12, one method of cooking is as follows:

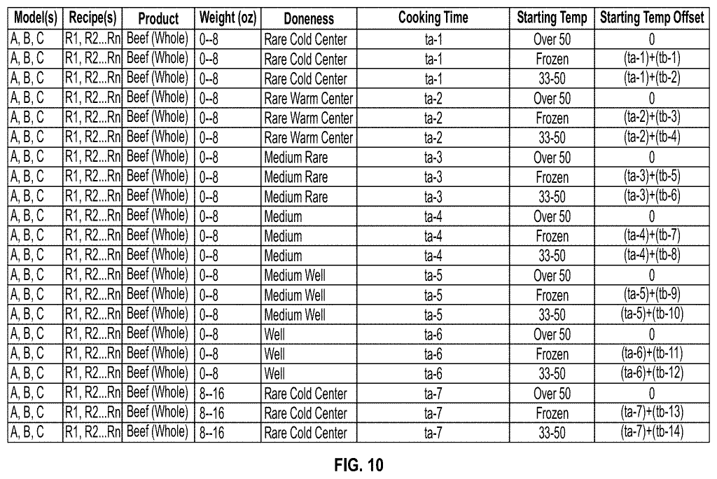

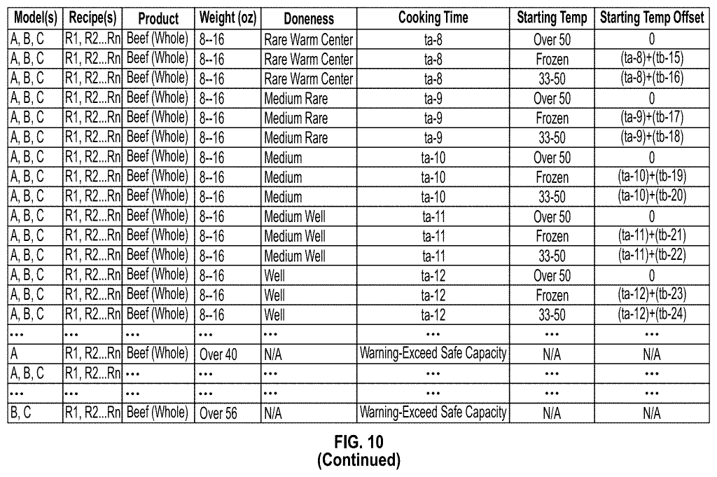

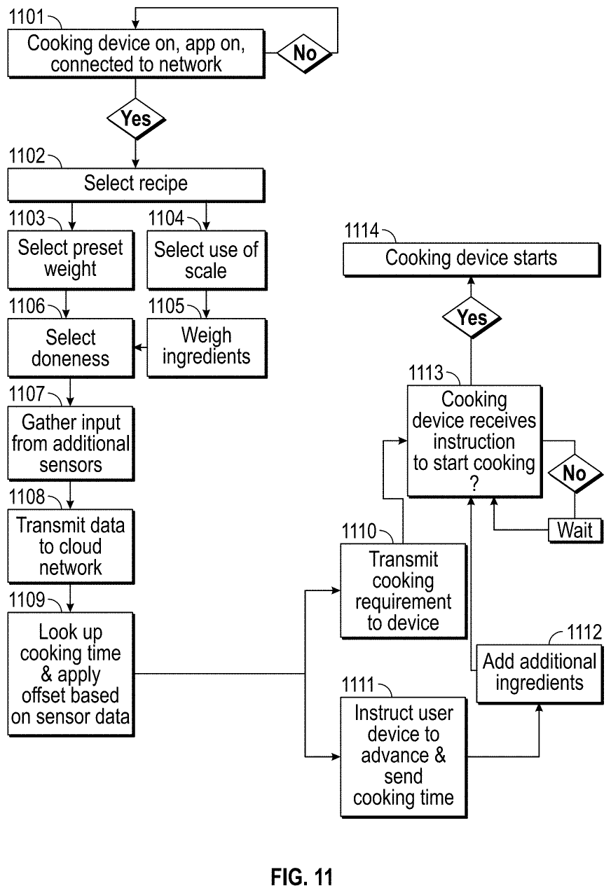

The controller 400 may display on the touch screen 402 a plurality of options and touch sensitive buttons corresponding to different cooking methods. The user selects a cooking method at 1201, for example, pressure cook. The controller displays a list of main ingredients to select from (e.g. beef, pork, eggs, beans), 1202. The user selects a desired ingredient to be cooked, 1203, for example pork. The controller may display options to refine the selection, 1204. For pork, it may display options for a whole roast or cubed meat. For beans it may display different varieties of beans. The user selects a refinement, 1205. In an embodiment, the refinement 1205 may be stored in the memory. In another embodiment, the refinement 1205 is predetermined and configured via a machine learning algorithm. In such an embodiment, the system may track preferences of the user and determine a likely refinement 1205. The controller displays options for measurements of the ingredient to be added (for example, cups or ounces) along with an option to use the integrated scale, 1206. The user selects a specific amount at 1207 or, if not, selects to use the scale at 1208. If the scale is selected, the controller causes the display to display a weight indicator, monitors the pressure sensors, and dynamically updates the weight indicator on the display based on pressure sensor data that changes dynamically as weight is added at 1209. In an alternate embodiment, the computer calculates characteristics of the food-to-be-prepared by cross-referencing the weight and type of ingredients 1205. As a non-limiting example, the computer may calculate the total calories of a food-to-be-prepared by multiplying the weight by the caloric density (calories per pound) of the ingredients 1205. The user selects an indication that they are done adding ingredients at 1210 and the controller advances to 1211. Or, if the user selected a specific amount, the controller advances to 1211. At 1211, the controller uses empirically determined data, such as data in the lookup table of FIG. 10 to calculate the proper cooking time, and based on the cooking type originally selected sets the cooking device for the proper cooking configuration and time. The controller displays options for manual adjustments, such as delayed start, or whether the cooking device should keep warm at the end of the cooking process, and the user may make manual adjustments at 1212. The controller then displays via the display a checklist to ensure proper operation of the cooking device at 1213. For example, for a pressure cooker, the checklist includes confirmation that proper liquid was added (the amount being calculated based on weight determined or selected), the lid is fitted with the proper sealing gasket, the lid is fitted to the housing and in the locked position, and the pressure valve is positioned properly. Sensors may provide feedback to confirm one or more of the foregoing. The controller displays a start option, and the user may select the start option to begin cooking. The controller utilizes the sensors to monitor the operation of the device, and if a problem is detected, such as the lid is not properly placed on the pressure cooker, the controller causes the display to display a warning message and may prevent operations of the cooking device.

Coordinated Cooking:

Cooking devices, including the multicooker discussed above as well as others, for example cooking devices equipped with controllers similar to the controller 400, may be coordinated together to work as part of a greater cooking system. The system includes a user computer 900, a network 901 which may include one or more remote computers (or servers) 902-1 through 902-N, an internet router 903, and a plurality of cooking devices 904-1, 904-2 . . . 904-N. The user computer may connect to other entities 910, 911, 912 connected to the internet (such as web based services hosted on internet connected servers), and the network 901 may also connect the other entities.

In one embodiment of the system, a recipe may call for an oven to bake for 40 minutes after pre-heating and call for a multicooker to pressure cook for 8 minutes. It may be unknown how long the oven will take to pre-heat. In an embodiment, the system may account for pre-heating via an algorithm. In a further embodiment, the algorithm may be configured to maximize pre-heating to decrease the required cooking time. For example, the algorithm may instruct the user to pre-heat the oven at a temperature that will decrease the time the ingredient must be within the oven. The multicooker may be filled according to a known recipe, and based on empirically obtained data for the particular recipe and the model multicooker it is known with a high degree of accuracy that the multicooker will take 5 minutes to pressurize. In one embodiment, the user computer downloads a recipe. The recipe takes into account the particular cooking devices that the user will be using to cook the recipe.

For example, the user may search a database of test kitchen recipes that are filtered by the cooking devices associated with the user. The association may occur by the user connecting the user computer to a cooking device in the first instance, and that information may be stored on the user computer or as part of a profile for the user that may be stored on the network. Alternatively, the test kitchen database may store a number of different recipes and, upon selection of the recipe by a user, the user computer or remote database identifies the cooking devices associated with the user that will be used to cook the food, and adjusts the cooking instructions of the recipe to match the cooking devices. In an embodiment, the user device (or database) also uses additional user data, such as location (which for example reflects altitude), and further adjusts the recipe instructions based on the additional user data.

Respecting the database and empirically determined data used to populate the database, in operation, the database may be broken into subsets of lookup tables for various ingredients. For example, one ingredient may be a whole beef roast. The database includes a table, such as the table shown in FIG. 10, having cooking values for the ingredient. FIG. 10 is merely exemplary and it should be understood that additional variables could be added and accounted for. For a particular models of cooking devices the weight of the product to be cooked is associated with a desired doneness and a cooking time. Different tables may be associated with different recipes as cooking times may vary for identical ingredients depending on the recipe. Additional variables, such as a starting temperature of the ingredient could also be included along with a further dependent variable such as an offset time. In the table of FIG. 10, cooking device A has a max capacity of 40 oz, and therefore if a roast over 40 oz is added, the cooking device produces a warning. Cooking devices B and C have max capacities of 56 oz. The cooking times ta-1, ta-2 . . . etc. and tb-1, tb-2 . . . etc. are exemplary and in practice may be the same or different.

A method of cooking utilizing the forgoing may be as follows. For example, Model A multicooker of the type described herein may be used. The process begins at 1101 when the cooking device and user computer are each turned on and connected to the network. The user selects on the user app or the cooking device a recipe with an ingredient or a specific ingredient to be cooked at 1102. The user may then select a preset weight of the ingredient 1103 or select to use the scale 1104. The weight information may temporarily be stored on the cooking device. The user selects the desired doneness at 1106. If there are dependent variables that may be applied based on additional data, the additional data may be gathered from sensors or input manually by the user before, along with, or after the weight data is obtained. In one embodiment, after selecting doneness, the cooking device checks for additional sensor data, such as data from a thermometer, or prompts a user to enter information about the ingredient (frozen, direct from refrigerator, room temperature) at 1107. The preset weight or weighed amount, desired doneness, and dependent variable data are sent to the cloud at 1108. The cloud network uses the lookup table to identify the cooking time based on the ingredient, weight, desired doneness and dependent variable data at 1109. The network then sends the cooking requirements to the device (such as time and temperature or other setting, slow cook, pressure cook, steam, etc.) at 1110 and may send an instruction to advance to the next step and may send the cooking time or other information to the user device at 1111. The user may then add more ingredients if necessary 1112. The cooking device waits for a user to select “start” on the cooking device or through the app (which sends an instruction to the cooking device to start) at 1113. Upon receipt of the start instruction, the cooking device starts cooking according to the cooking requirements of 1110. The cooking device, app, or both may then display the cooking progress (for example, the time until completion, the current cooking method being employed, or information regarding the temperature, pressure, and/or other environmental characteristics within the cooking device).

In an alternate embodiment, rather than transmitting the data to the cloud at step 1108, the controller of the cooking device accesses the memory of the controller in which ingredient data tables are stored. The controller provides cooking instructions based on the stored data tables and adjusts the settings of the cooking device accordingly. The user may then proceed to cook the ingredients by activating the cooking device.

In one embodiment, the system may include a recommendation engine that, based on certain variables/preferences, recommends another (or recommends avoiding another) recipe or ingredient. For example, if the user selects “medium well” as a cooking setting, the system may recommend that texture with extra pepper, or may prompt that if the user selects their meat to be “charred,” it recommends avoiding certain ingredients. The recommendation engine may be built or derived from a spreadsheet or table that assigned particular flavors, temperatures, or other characteristics with correlating flavors, temperatures, or other characteristics. As a non-limiting example,

The cooking system may coordinate multiple devices. For example, in one embodiment, a first cooking device, such as an oven, can send signals to a second cooking device, such as a multicooker (either directly or indirectly, for example, through the user computer) to inform the multicooker of the timing of its cooking process (for example, that it has finished pre-heating and is starting the 40 minute cooking cycle, or that it has a certain amount of time remaining in the cooking cycle). For example, oven may send signals to the user device which, based on the recipe being followed, determines what operations the multicooker must perform to accurately complete the recipe, and then the user computer may transmit data, such as instructions, to the multicooker. The multicooker can use that data to react to an instruction, or, for example, to determine when to turn on to start the pressure cooking cycle so that the food in the oven and food in the pressure cooker are cooked in coordination with each other (for example to finish at the same time, or at a predetermined offset time). In that way a user can select a single recipe on the user device, and the user device will coordinate among the multiple cooking devices to accurately complete the recipe. Alternatively, the user may input one recipe into one device, such as the oven, and leave while the oven coordinates the cooking process among multiple devices. In one embodiment, the oven may coordinate the cooking process only with preset recipes. In another embodiment, the oven may coordinate the cooking process based on past cooking history of the user. In such an embodiment, the cooking device may be equipped with a machine learning algorithm, enabling the cooking device to coordinate the cooking process based on the steps taken by the user previously. For example, if the user frequently cooks chicken parmigiana, when the cooking device recognizes chicken and parmesan cheese within the proximity of the cooking device, the cooking device may instruct the oven or the user to pre-heat to the required temperature for chicken parmigiana. In one embodiment, the recipes on the cloud network are numbered, and a user may enter the recipe number into a cooking device (or into the user computer) which then downloads operational data based on the recipe number and automatically sets the cooking device(s) to cook ingredients according to the recipe. For example, the user computer utilizes the recipe to determine the cooking time for the food in the oven, determine the cooking time for the food in the multicooker, and coordinates activating the oven for the correct time and temperature and activating the multicooker at the proper time and setting to complete the full recipe.

In one embodiment, the system may include an algorithm that increases precision. For example, the algorithm may influence the system to be more efficient power-wise or environmentally, taking the time the cooker is expected to finish, and syncing the oven to turn on or be pre-heated to the right temperature at the most efficient time. In such an embodiment, the system may minimize waste and increase efficiency.

In an embodiment of the system developed utilizing the cooking devices, user computer, and cloud network, the system utilizes a calculator search function. The calculator search may be presented as a search engine on the user computer (or other device). The calculator user interface may have a search bar, which enables the user to enter an item (for example, a type of food or an ingredient). The calculator may search as the user types, meaning the results may return and populate as the user enters the search term. As a non-limiting example, if the user types “s” into the search bar, the search results may be populated with “salmon,” “sausage,” and “soft boiled.” In one embodiment, the search term may be highlighted (or otherwise identified, for example, bolded, italicized, or presented in a different color) in the search results (for example, if the user types “sa” into the search bar, the search results may present “salmon” and “sausage” with the first two letters of both terms highlighted). In an embodiment, each of the search terms is also accompanied by a path a user may use to get to the item. As a non-limiting example, the search results “squash” may include the path “squash->acorn squash.” The path may be presented above, below, aside, or in any proximity to its corresponding search result. In another embodiment, each search result may also present along with a corresponding section or category. For example, the search result, “squash,” may be accompanied by the section “vegetable.” In an embodiment, the search results may be sorted by section from top to bottom, then each section sorted in alphabetical order. However, in alternate embodiments the search results may be sorted in any manner using any method. In one embodiment, the calculator search may also include a “did you mean” feature. In such an embodiment, if there are no search results for a search term, the system may suggest search terms (for example, the correct spelling of a misspelled ingredient).

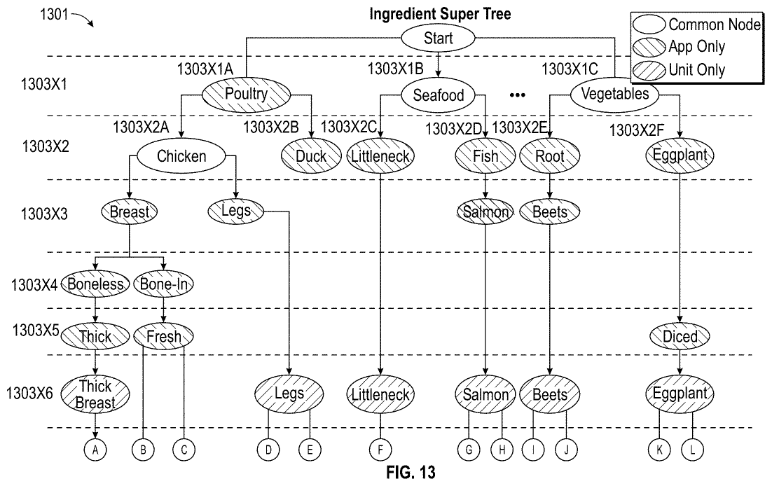

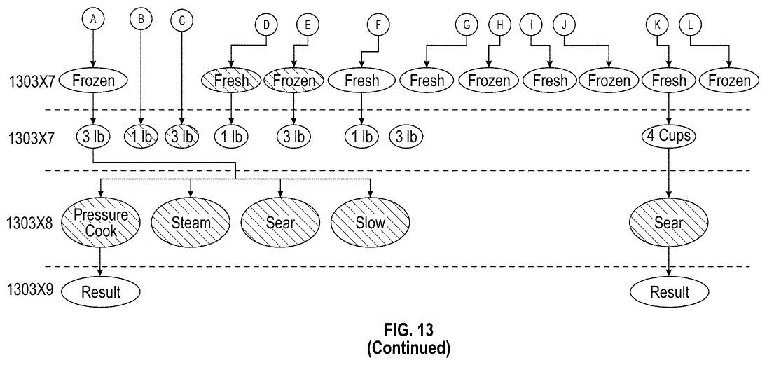

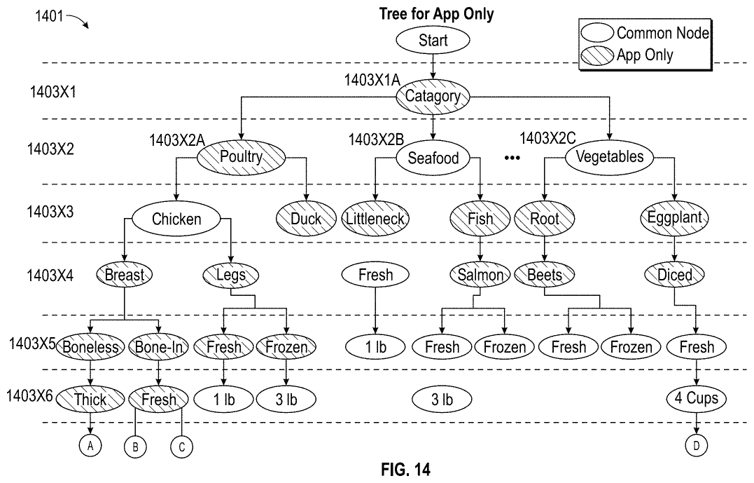

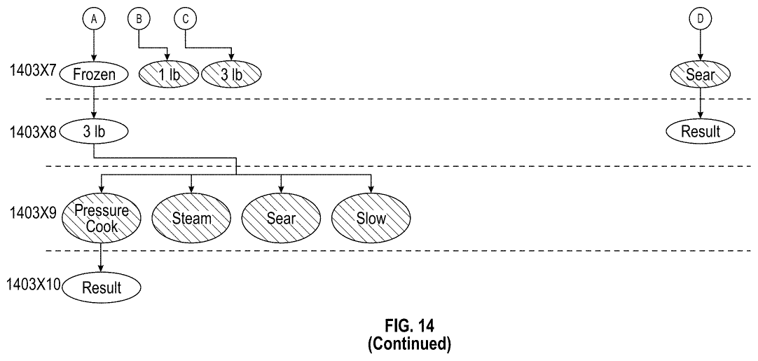

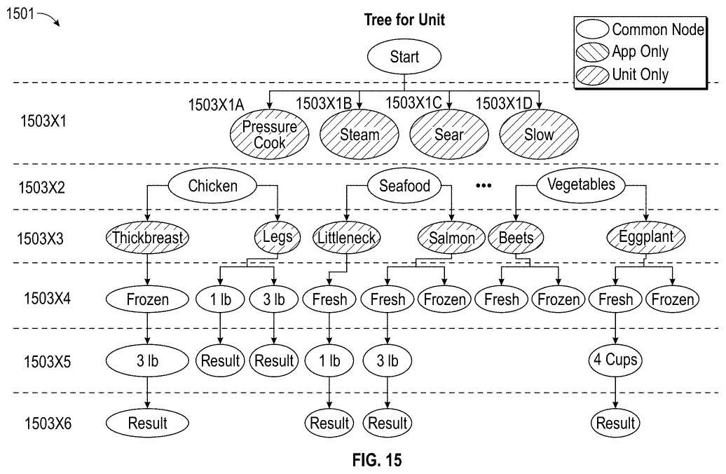

Referring to FIG. 13, in an embodiment, the data that is available to the calculator search will be stored as super trees 1301 and subtrees. Each subtree, for example, may correspond to each product type and may be rooted in any node. For example, super tree 1301 may contain rows ranging from 1303X1 to 1303X9. Each row may contain any number of nodes, for example, 1303X1A through 1303X1C. As an example, a subtree may be rooted in node 1303X1C (“Vegetables”), exclusively containing each node that flows from 1303X1C (for example, 1303X2E (“Root”), 1303X2F (“Eggplant”), and the nodes that flow from the aforementioned). The ingredient information may be stored in different tables or structures. For example, a super tree may be stored be stored in MySQL where each node will be stored as a row. Each node may refer to the corresponding card via the card_id and section via the section id. There may be a card for every node, containing information like the name and icon location. Referring to FIG. 14, the tree for the app may be generated from the super tree containing only the nodes that are valid for the app. For example, tree 1401 may contain nodes that are relevant for app function. Tree 1401 may contain rows 1403X1 to 1403X10. Each row, for example 1403X1, may contain nodes 1403X1A through 1403X2C. Each node may contain the full card and section information. Such a tree may be stored just like the super tree but in a different table in MySQL. Referring to FIG. 15, trees for the unit (for example, the cooking device) may be generated from the super tree containing only the nodes that are valid for the smart cooker (or other cooking device). For example, tree 1501 may contain nodes that are relevant for unit function. Each row, for example 1503X1, may contain nodes 1503X1A through 1503X1D. This j son block may be generated at build or release time of the FW and may be stored in Bitbucket along side the code. A tree may be created for each cooking method for the smart cooker. In an embodiment, any number of nodes across tree 1301, tree 1401, and tree 1501 may be identical. In an embodiment, tree 1401 and tree 1501 are derived from tree 1301.

In one embodiment, the supertree (or sub tree) may be derived from a table; the table having a number of columns. The “mode type” column may specify the type of node, for example “root” (the topmost node that is the starting node of the tree), “internal” (a node that has one or more children), and “external” (a node that has no children, thus, containing results). There may also be a column for “calculator types.” Such a column may include the types of calculators. As non-limiting examples, this column may include, smart cooker, pressure cook, steam cook, slow cook, sear/sauté, etc. In an embodiment, the application includes an app tree created from the super tree based on the device selection. For example, one tree may be created for the smart cooker and one tree for the thermometer. App trees may be stored in the same table as the super tree table.

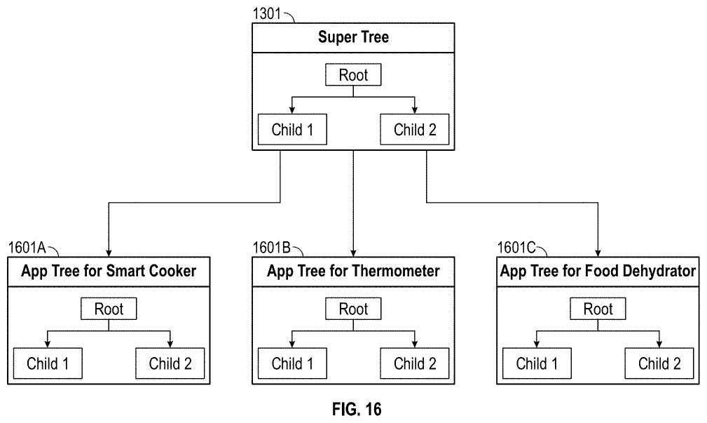

In an embodiment, the application may retrieve a subtree of a particular internal node by specifying the number of generations. As a non-limiting example, to retrieve the next two levels of children, one may call the API and specify the two generations of that node. In such an example, the app may not need to fetch the entire tree (which may be very large) and may instead fetch the subtrees based on the selection the user has made. Each tree node may be returned as a flat JSON structure where each node contains attributes such as card information (icon, name), children, and other characteristics of the node. The results may be embedded in the leaf node inside the “data” field as a JSON block. In one embodiment, another API may aid in fetching results options for handling the fields for the results node. The application may map the fields in the results node to the result option and display the result accordingly. In one embodiment, the handling of each of the setting parameters in the results may be stored in a table (for example, “result_options”). The display title and what values to send to the unit may be some attributes of the aforementioned settings. For example, as illustrated in FIG. 16, the super tree 1301 may be separated into sub trees 1601A-C, having a root from a particular node. Such an example embodiment, may allow the application to recall the necessary segments of the super tree 1301, without recalling intensive or superfluous elements.

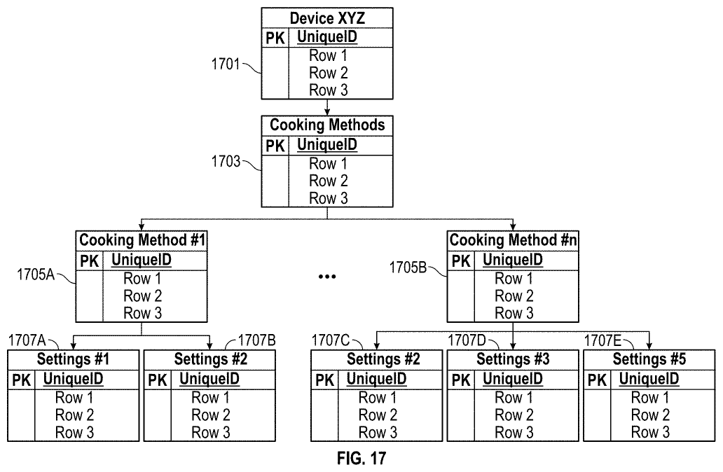

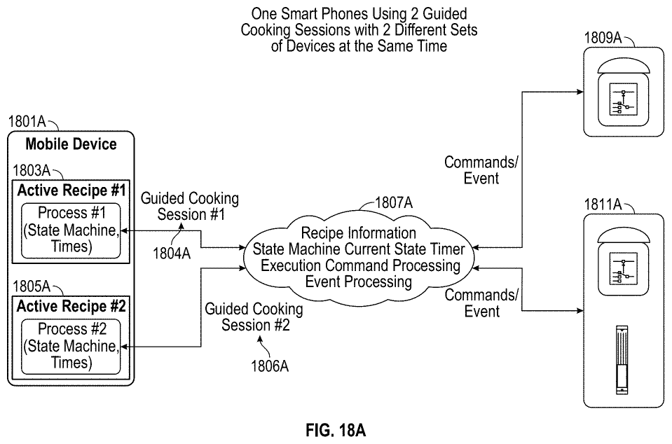

Referring to FIG. 17, in an embodiment, the system may include a smart bar, which may display various options based on the cooking method selected for the device. In an embodiment, the device data 1701, may be categorized into method data 1703, containing a list of cooking methods. Each cooking method nested within method data 1703 may be visualized as a cooking method dataset 1705A-B, and further categorized by setting datasets 1707A-E. In one embodiment, such information may hardcoded in a local configuration file. However, in another embodiment, the information may be fetched from the backend. The settings parameters may include any of the following fields: “setting_id,” version, name (settings name, valid values may be: timer, heat level, release mode, keep warm, and temperature level), icon, and values (for example, valid values). The settings table may include a setting_id and its corresponding display name and parameter name. As a non-limiting example, setting_id 1, may correspond to display name “Cooking Time,” and parameter name “cooking_time.” In a further non-limiting example, seting_id 1 may include values dictating the minimum and maximum cooking time, granularity of cooking time, and default cooking time. However, each setting_id may contain a corresponding set of values. The table may also include method_id, where the method_id matches the id used by device (for example, smart cooker or multicooker). As a non-limiting example, possible values for method_id may include each cooking method and its corresponding id (pressure: 0, sear_saute: 1, steam: 2, etc.)

In one embodiment, one of the devices in communication with the cooking device, user computer, or cloud, may be a “smart fridge” (for example, a refrigerator equipped with sensors or other means of determining the refrigerator's content). In such an embodiment, the cooking device, user computer, or cloud may take into account what ingredients are within the refrigerator. If an item is not within the user's refrigerator, that item may not appear on the calculator search or may appear in conjunction with a notification to the user. As a non-limiting example, if the user is attempting to prepare alfredo sauce and the recipe calls for heavy cream, but there is no heavy cream within the refrigerator, the refrigerator may send a signal to the cooking device, alerting that a substitute is necessary. In a further non-limiting example, the cooking device, in communication with the refrigerator, may recognize that there is a stick of butter in the refrigerator, and suggest to the user to utilize a modified recipe including butter instead of heavy cream. In an alternate embodiment, the user's cupboards, cabinets, and pantry may be equipped with sensors in communication with the cooking device, user computer, or cloud. In such an alternate embodiment, similar to the embodiment including a smart fridge, the sensors may be configured to inform the system which ingredients are present and which are absent.

Coordinated Recipes:

In one embodiment of the system developed utilizing the cooking devices, user computer, and cloud network described herein users may coordinate the preparation of a recipe through the use of the app operating on the user computer in conjunction with a user profile connected with the app. The user profile, which is preferably stored in the cloud network, stores information pertaining to a particular user. Such information may include, by way of nonlimiting example, one or more of the following: dietary needs (i.e. calorie goals, allergies, restrictions, vitamin needs, vegan, etc.), identities of cooking devices that are compatible with recipes, food preferences (i.e. spicy, sweet, acidic, etc.), cuisine preferences (i.e. Asian, Mexican, Italian, etc.), favorite recipes, etc. For an embodiment utilizing a calorie goal, the system may sync with a wearable device, such as a FitBit® and cross reference the extracted data with the recipe calories to generally match the calorie goal (i.e. positive calories, negative calories) with the user's activity level. The information may also include account sync data (such as name, password) for third party services such as Instacart™ or other grocery delivery service, for example a service operated by the cloud network.

In one embodiment, each of the user profile options are presented as check boxes, radio buttons or similar interface that may only be selected or not selected (i.e. set to true or false). Recipes uploaded onto the system are uploaded with metadata corresponding to the various options. The network may then match recipes for users by comparing the recipe metadata with the user's profile. Additionally, preferences may be set for the options, such as mandatory (such that all recipes must include the option), prohibited (all recipes must not include the option) and optional. In one embodiment, the user may input a degree of adventurousness that corresponds to how strict the network must be in following the preferences, taking into account the preference settings. In such an embodiment, each recipe, food, or ingredient may be associated with an adventurousness value (for example, an exotic spicy dish having an adventurousness value of 5 out of 5), the degree of adventurousness may be a numerical value selected by the user. In such an embodiment, the network may not show recipes to the user that have an adventurousness value above the user's degree of adventurousness. In an embodiment, the degree of adventurousness may be a function of the variety of foods prepared by a user or the fluctuation in recipes chosen by the user. In such an embodiment, the degree of adventurousness may be determined by the system in conjunction with an algorithm. For example, if a user selects recipes from a wide spectrum of flavors, the user's degree of adventurousness may be high. The user may also link favorite recipes to the user's profile, and the network may use data about the recipes to learn preferences of the user (for example, a user tends to save or highly rate beef recipes, but rarely saves or negatively rates lamb recipes, and the network will tend to show more beef than lamb recipes).

A user may select a specific recipe, or request a recipe based on preferences. For a requested recipe the system compares recipe metadata to the preferences and calculates a percentage match that is compared to the user's adventurousness. Recipes within the tolerance set by the user may then be presented to the user. Having the user create and saves a user profile on the cloud allows the system to more effectively identify compatible recipes than a mere keyword search. That is because the profile and recipe comparison tool may both be stored remotely from the user computer, and therefore the network can process data pertaining to the user when the user is offline. As recipes are added or after a user changes preferences, the network can routinely run comparisons to identify compatible recipes and associate those recipes with the user profile. When a user logs on, the user's profile is prepopulated with a selection of recipes compatible with the user's criteria. By prepopulating the recipes, a user need not utilize processing power on the user device to sync search requirements, and can reduce search time by confining searches to recipes with known compatibility. Thus, a user may log on to the profile, and search “mushroom” and the network may confine the search to only those recipes prepopulated for the user, as opposed to the whole network of recipes, and return the results. The user need only select the desired recipe without needing to review the ingredients to ensure compatibility with the user's preferences, thereby reducing the time the user needs to spend looking for a recipe.

One embodiment of the operation of the system is described in exemplary manner below.

The test kitchen makes a recipe, such as, with branded products. That process may be repeated numerous times to empirically develop a database of ingredient inputs, cooking parameters, and recipe outcomes.

The test kitchen uploads recipe with cooking parameters, ingredients, and outcomes to cloud. The upload further includes metadata for the recipe.

A user having a user profile uses a user computer and app to access the user's profile including gaining access the test kitchen recipes. The app further gains access to the database of outcomes table for recipes that have variable outcomes based on user preferences.

The user uses the user computer app to search for recipe(s). Alternatively, the app may present a recipe to user, for example based on previous recipes or user likes or dislikes, or alternatively based on past purchases/recipes and the assumption that user has leftover ingredients. The user may then select the recipe to make.

In one embodiment, the user's profile is linked to a grocery ordering or delivery service. Upon selection of one or more recipes by the user, the app determines the ingredients necessary to make the recipe, and then places an order for the ingredients through the linked service. The selection of ingredients and ordering may be done automatically once the user approves the recipe(s). In one embodiment, user selects many recipes, for example, recipes for one week, two weeks, three weeks, etc. of meals, and the user computer or cloud stored user profile associated with the user computer staggers purchase of ingredients so that fresh ingredients are provided to the user at appropriate times.

As the user selects multiple meals, the network may calculate the ingredient amounts needed and present to the user (or highlight for the user) recipes that will use predicted leftover amounts of ingredients from prior selected recipes. As part of the user profile, a user may also input any ingredients they have on-hand (e.g. soy sauce) and the network may account for those ingredients as leftovers. In one embodiment the user deselects ingredients or selects things they do not have (or extra ingredients they want to purchase) and the network may include those additional items in the order. Predicted leftover amounts may be calculated as a function of the user's past selected recipes and current ingredient inventory. In such an embodiment, the system may have a list of the user's ingredients on a particular day (for example, the user may have input all their available ingredients purchased after a trip to the supermarket). Further, the system may keep track of ingredients as they are used in various recipes (for example, subtracting the amount of a particular ingredient used from the running available ingredient list). The system may then present recipes utilizing only ingredients on the running available ingredient list. In one embodiment, the running available ingredient list is stored on the memory or in the cloud. In an embodiment, the running available ingredient list may further receive input from optical sensors or other sensors configured to keep track of ingredients in the user's kitchen. For example, an optical sensor may be disposed within a user's refrigerator, reporting the SKUs of food products to the system to be added to the running available ingredient list.

Once the user confirms an order (for example by completing the identification of one or more recipes the user would like to make), the network uses the users account sync data to connect to an online shopping store and syncs the user's shopping list with the appropriate ordering requirement (which may be done automatically or manually). The order is executed and the groceries are delivered to the user. In one embodiment, the ingredients are ordered through a traditional grocery. In one embodiment the ingredients are ordered through a meal-prep service that does some pre-prep (e.g. cutting or measuring or compartmentalizing the ingredients for each recipe to the extent possible.).

The user profile may be updated to reflect any purchase product that, per the recipe, results in leftovers (e.g. left-over bbq sauce). The leftover ingredients may then be used as variables in follow-up recipe selection sessions. In one embodiment, the system is configured to curate the list of leftover ingredients or the running available ingredient list based on the shelf life of food products. For example, although a carton of milk may physically be on-hand in the kitchen, the system may remove the carton of milk from the list five days after it was added to coincide with the likely shelf life. In one embodiment, the system may alert or warn the user that a food item has spoiled or is likely to spoil soon. In another embodiment, the user inputs the “sell-by-date” or expiration date for a particular food item into the system.

Guided Cooking:

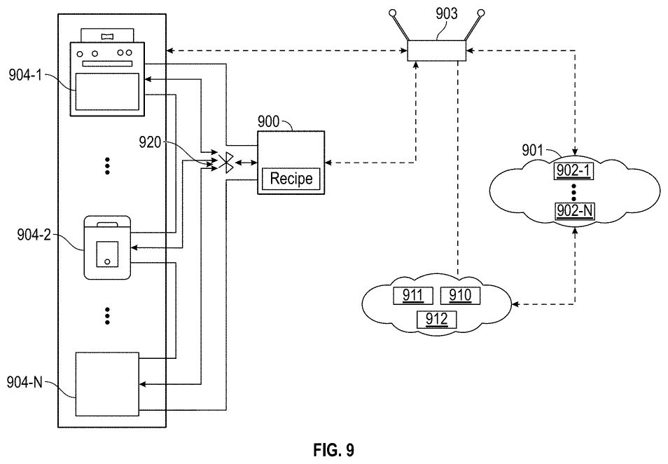

With reference to FIG. 9, the cooking device 904-2, for example, may connect to a user computer 900. When the cooking device is first turned on, it transmits a signal, such as by Bluetooth searching for a connection with a user device. In FIG. 9, the Bluetooth communication connection is shown generally as 920. The user device includes software that allows the user device to connect to the cooking device. The software may display the make, model, or picture of the device. The user computer may then pair with the cooking device such that the user device may be used to control the operation of the cooking device. Once paired, the user device and cooking device may utilize a wi-fi connection available from, for example, a router 903 to transmit data between them. In one embodiment the user device can also be used to connect multiple cooking devices together, for example through Bluetooth connectivity, such that the multiple cooking devices 904-1 through 904-N, and may send and receive data and instructions directly between them, or may use the internet to rout communications to one another through the network 901 utilizing the user profile. In one embodiment, after an initial setup procedure, the cooking device utilizes a wi-fi connection to connect to a remote computer 902 (for example, a cloud based network of servers 902 through 902N). The user computer likewise connects to the cloud via the software application on the user computer. The user computer and cooking device may then communicate with each other wirelessly through the cloud network.

The user may access the cloud database where there is stored recipes and the empirically determined data from the test kitchen supporting the recipes. The recipes may be curated specifically for the database. For example, in one embodiment, a test kitchen gathers food stuffs, for example brand name food stuffs and fresh ingredients, and prepares dishes using those food stuffs and a particular make and model cooking device. The test kitchen may prepare a number of the same dishes repeatedly to empirically determine the optimal cooking parameters for specific name brand foods in connection with specific makes and models of cooking devices and store the input variables and recipe results in a database. Additionally, the test kitchen may create multiple versions of the same recipe to account for alternative environmental concerns, such as ambient temperature, humidity, and altitude. The cooking device may be equipped with sensors that sense the environment. The data from the user computer may also be ascertained, such as the user location which may then be translated into the user's altitude or information from a user's smart home (such as Nest™) that is connected to the user device, such as ambient temperature and humidity. The data may be compiled by the cooking device or user app and when the user selects a particular recipe from the cloud, the environmental data may be processed and used to select the appropriate recipe instructions for that user. For example, a boiling cooking time may be longer for a user at high altitude than for a user at low altitude, or a dough rise may be longer for a user in a cooler environment than one in a warm and humid environment. In one embodiment, the cooking device may be equipped with one or more thermometers, barometers, hygrometers, salinity meters, or other environmental characteristic measuring devices. Each of environmental characteristic measuring devices may be disposed within the cooking device and/or outside the cooking device (for example, configured to detect characteristics of the environment of the kitchen). In another embodiment, the cooking device is in communication with a weather forecast (for example, a direct communication between the cooking device and a weather forecast or directed through the cloud or user computer). In such an embodiment, the cooking device may account, not only for the current environmental concerns, but also predictive environmental concerns. As a non-limiting example, a recipe may be tailored to an environment at 1010 millibars of pressure; however, a storm system of 975 millibars of pressure may be rapidly approaching. In such a non-limiting example, the recipe and/or the cooking device may tailor cooking to rapid pressure shift. In a further embodiment, the cooking device may utilize temperature, pressure, humidity, or other readings to better maintain the internal temperature, pressure, humidity, or other conditions of the cooking device. In an alternate embodiment, the cloud, the user computer, the controller, or other device in communication with the cooking device, may include climate data (for example, a spreadsheet of coordinates and corresponding typical environmental conditions). The cooking device may also be in communication with an internet-enabled weather forecast.

The user may use the user computer to download a program (app) that pairs the user computer with one or more cooking devices and an online account/profile that accesses data stored remotely from the user computer and the cooking device (such as on a cloud server). The remote data center (which may be one or more internet connected computers or servers) stores recipes, instructions, videos, articles, and is a portal for users to network with others and share information.

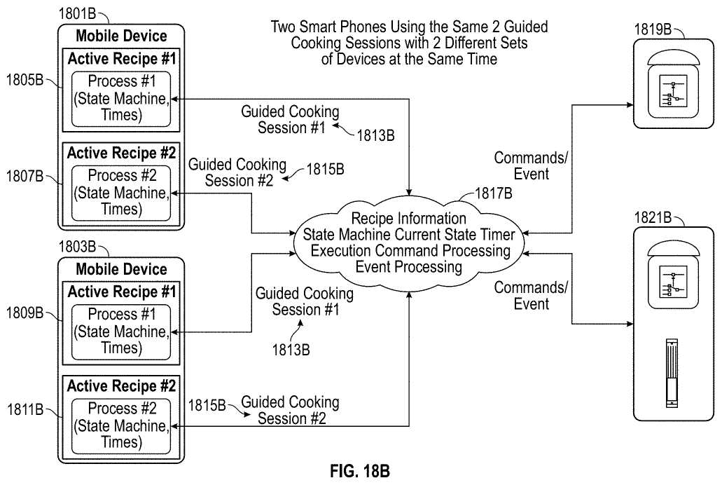

Referring to FIG. 18A, in an embodiment, the user computer 1801A may include an app running a first active recipe 1803A and a second active recipe 1805A. Each active recipe 1803A-1805A may be associated with a guided cooking session (for example, active recipe #1 may be associated with guided cooking session #1 1804A and active recipe #2 may be associated with guided cooking session #2 1806A). The user computer 1801A may further be in two-way communication with a cloud server 1807A (in some instances, holding the bulk of information). Further, the cloud server 1807A may be in two-way communication with two or more cooking devices 1809A-1811A. Referring to FIG. 18B, in another embodiment, there may be two user computers 1801B-1803B, each user computer 1801B-1803B running the same two guided cooking sessions 1813B-1815B. In such an embodiment, both user computers 1801B-1803B are in communication with the cloud server 1817B, and the cloud server 1817B is in communication with two or more cooking devices 1819B-1821B. In such an embodiment, user computer 1801B may be running active recipe 1 1805B and active recipe 2 1807B. Further, user computer 1803B may be running active recipe 1 1809B and active recipe 1811B. In one embodiment, if a user attempts to activate a recipe on their user computer, but the necessary cooking device is already in use by another user, one or more of the user computer may alert one or more of the users. In such an embodiment, a queue may be formed based on the time when the user attempted to use the cooking device. The second user may be presented alternatives based on cooking devices that are available. In an alternate embodiment, the second user computer may have override functionality, allowing the second user to disrupt the first active recipe.

A user may use the app to access the user's profile and download a recipe or other information. The recipes may be the product of empirically determined steps and ingredients derived from test kitchen work. The recipes include the ingredients required (and may include the specific brands of the ingredients when available) and the times and settings of the cooking device needed to cook the recipes. The recipes provide step-by-step instructions, which may be accompanied by video or audio instructions, that may be displayed through the app for the user to follow. In another embodiment, the step-by-step instructions may be interactive. As a non-limiting example, the cooking device may be in communication with the user device (which may be displaying the instructions) and may inform the user device when the user has completed one of the steps. For example, if step 1 is to add one pound of chicken to the cooking device, once the scale in the cooking device detects one pound of weight, the cooking device may send a signal to the user device, advancing the instructions automatically to step 2. The app may further assist the user by sending signals to the cooking device such that the cooking device automatically adjusting its settings to the correspond with the setting required for the recipe, for example by setting a multicooker to slow cook and setting a timer to 4 hours. The app may send an instruction to the user encoding the information relating to the cooking device settings. Alternately, the recipe the user is following may be sent to the cooking device and the app may send a signal indicating that the user has progressed to a particular step, at which point the cooking device may recognize that the next step requires the cooking device to exhibit particular operations and the cooking device computer adjusts the operation of the cooking device accordingly.

In an embodiment, a recipe may have information associated with it. As non-limiting examples, the recipe may include ingredients (for example, all the ingredients and quantities), yield or serving size (for example, the serving size for a given amount of ingredients), cooking methods, active time (for example, the total time required on the device itself), total time (for example, the total time the recipe may take from start to finish), and steps (for example, detailed steps for cooking). In an embodiment, the steps may further be subdivided into types of steps including, but not limited to, preparation and manual steps (may require users to carry out manual activities such as chopping ingredients or sitting until desired consistency is reached), device operation steps (may require connectivity to a device so that cooking parameters may be sent to the device or may require manual operation, such as setting the knob or closing the lid), and waiting or timed steps (may require users to wait for an event to occur). A step may further be subdivided into characteristics, for example: description (text that indicates the actions required of the user), ingredients (ingredients and respective amounts used in this step), actions (the command that will be sent to the device to start cooking, cooking time, temperature level, pressure, pressure release mode), conditions (the conditions that must be met in order to execute the corresponding step), has timer (if a timer must be started), and stop conditions (conditions that will stop the cooking session immediately). If an error occurs in the device, the device may update the state in the backend, triggering analysis of the failure. Potential errors include, but are not limited to, overheating, preheat failure, building pressure failure, temperature sensor failure, pressure switch failure, high pressure switch failure, low pressure switch failure, heater failure, and communication failure. Each operating error may have a corresponding operating error type and number. In the event of an error, the device may stop its current function and alert the user to the error (for example, displaying a text message on the user interface).

In one embodiment, the recipe is sent from the app to the cooking device. The user begins the recipe by indicating that the user is starting, such as by entering a start command. For example, the user may press a start button on the cooking device or user computer, or the app may use the microphone of the user computer (such as a mobile device) to accept voice commands and a user can avoid touching the user computer and the cooking device with food soiled hands during the recipe. It is further contemplated that the cooking device may be equipped with additional sensors, such as a microphone to accept additional inputs rather than only using inputs from the touch screen and dial. In another embodiment, the cooking device or the app may be equipped with accessibility features (for example, features that increase usability for those with disabilities). As non-limiting examples, the cooking device may be equipped with a speaker which reads aloud recipes (text-to-speech), braille may be disposed upon the user interface, text-size may be increased with a zoom function, or the cooking device may be in communication with a third-party device designed for individuals with disabilities.

As a non-limiting example, a recipe may call for a multicooker to cook 2 oz. oil, 4 oz. of wine, 1 lb. of chicken, ½ lb. of onion, 1 oz. garlic, 14 oz. tomatoes, salt and pepper where the onion and garlic are simmered in the oil for 5 minutes, the other ingredients are added, and then everything is pressure cooked for 8 minutes. The app may instruct the user to get all the ingredients out and click start when the user is ready to begin. Upon providing the indication to start, the multicooker will begin heating to a simmer stage, the instruction states to add the oil. The user may begin to pour oil into the cooking pot inside the multicooker. The scale of the multicooker displays the weight of the oil dynamically to provide an indication of when the user hits 2 oz. (or at least sufficiently close to 2 oz.). The multicooker sends a signal to the app that the weight was satisfied or that the process should move to the next step. Based on timing or a sensor, the muticooker determines that the oil had reached an appropriate heat and alters the user either through a notification from the multicooker, such as a display change or audio signal, or by sending a signal to the user device which the user device processes and then provides the feedback signal to the user.

The recipe automatically moves to the next step once the oil was added and the device begins to heat. The recipe may instruct to chop onions, and may provide a video, which may be inset in the user display, showing chopping technique and preferred size. The user chops onions. In one embodiment, the camera on the user device (or an added photosensor or camera on the cooking device) captures the user's chopped food as it occurs, determines (for example by estimating, for example, by analyzing the size ratio between the uncut union and the cut pieces) the size of the chopped food, and compares that size to the preferred size based on empirical data from the test kitchen. The app may then provide feedback to the user to modify the size of the chop or encourage the user that they are preforming accurately. The system may estimate the size of material by utilizing reference points. For example, the user may present a scale in the frame of the camera that the system may then use to estimate the size of other objects. Alternately, the system may include preset estimations of the size of objects, for example the average size of male or female hands, or the size of a typical chef knife, and use those estimates as references. Via data received from the camera, the system may determine that the user is done with the onion chopping step, or the user may indicate that they are done and the app moves to the next step. It may instruct the user to add the onions and the garlic and the multicooker may provide feedback about the weight of the ingredients as they are added. Once added, the app or multicooker may automatically start the timer for the user to simmer for 5 minutes. At the conclusion, the multicooker may automatically adjust to the next setting, for example a warm/hold setting while the other ingredients are added. The process continues with the recipe guiding the user through the preparation and additions of the next ingredients. At any time the user may select the level of instruction desired such that the app may provide detailed feedback and instruction (such as with videos and feedback generated from sensors) or the app may scale to no feedback and minimal instructions such as chop, add, sauté, etc. The user may also override the automatic settings, for example, if the user wants to slow cook longer than a recipe calls for, the user can override the recipe by inputting a new time either on the multicooker or through the app.

Once all ingredients are added, the app or multicooker may provide an indication to place the lid on the multicooker, lock the lid, and close the pressure valve. The multicooker may then transition to pressure cook. In one embodiment, activation of the pressure cook mode requires confirmation from the user to proceed. The multicooker cooks the food according to the recipe and alerts the user when complete.

Networking:

Users may also perform the function of the test kitchen and prepare recipes for cooking devices. The recipes may be uploaded to the cloud. Once in the cloud, others may download and use the recipes. In one embodiment, user recipes are tagged separately from official test kitchen recipes. As an input parameter for the user profile, users may permit or prohibit user created recipes from being presented by the network. In one embodiment, user recipes originating from unique sources are provided with unique identifiers, and users may permit or exclude recipes that originate from one or more unique identifiers. Users may rate the various recipes. In an embodiment, users may take a recipe from another user and modify the recipe to their taste. For example, the system may take a recipe, analyze it for qualities, and then advise specific ingredients or steps based on the user's preferences. For example, the user may want the recipe to be “extra spicy” and the system may tailor the recipe to that request. Users may permit or exclude recipes that have a threshold rating, have a threshold rating and also have a threshold of total reviews, or that have a threshold rating by a particular unique identifier. Users may also store recipes on their app or on their cooking device. In one embodiment, the recipes may be exported to social media programs and platforms.

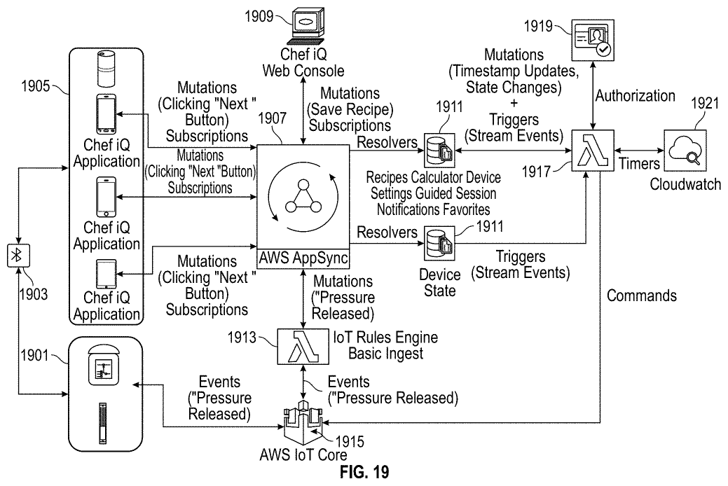

Referring to FIG. 19, the network may be configured to include, a cooking device 1901 in wireless communication 1903 with one or more user devices 1905. Each user device 1905 may be in communication with an intermediary 1907. In an embodiment, the intermediary 1907 may be configured to manage and update mobile application data in real-time between devices and the cloud (for example, AWS AppSync). The intermediary 1907 may further be in communication with a web console 1909, one or more servers 1911, and a rules engine 1913 (for example, an IoT Rules Engine). The rules engine 1913 may be in communication with an IoT-to-cloud broker 1915 (for example, AWS IoT Core). The IoT-to-cloud broker may also be in communication with a secondary engine 1917 (for example, another IoT Rules Engine) and the cooking device 1901. The secondary engine 1917 may also be in communication with the one or more servers 1911. The secondary engine 1917 may also be in communication with an authorization client 1919 and a monitoring and management service 1921 (for example, Amazon CloudWatch).

Although the present device and system has been described in terms of various embodiments, it is to be understood that such disclosure is not intended to be limiting. Various alterations and modifications will be readily apparent to those of skill in the art. Accordingly, it is intended that the appended claims be interpreted as covering all alterations and modifications as fall within the spirit and scope of the invention.

What is claimed is:

1. A cooking apparatus comprising:
an outer housing having an annular wall defining a height of the outer housing and a base;
an inner lining disposed within the outer housing and having a bottom connected to an annular sidewall extending up from the bottom and terminating at a rim, the sidewall and bottom defining an insert cavity that is open at the rim;
a housing cavity defined by an interior annular portion of the outer housing, an exterior annular portion of the inner lining and the base;
an insert comprising substantially the same size and shape as the inner lining so as to fit within the cavity;
a controller disposed within the cavity outer housing;
a heating element connected to the controller;
a user interface disposed on the annular wall of the outer housing and comprising a display and at least one input sensor;
the base further comprising a plurality of feet;
the plurality of feet comprising pressure sensors wherein the pressure sensors are in electrical communication with the controller;
wherein the controller is configured to receive input signals corresponding to electrical communications from the plurality of pressure sensors and, in response to the receipt of the input signals, display on the display an image corresponding to a pressure sensed by the plurality of pressure sensors.

2. A cooking apparatus as in claim 1 wherein the user interface comprises a touchscreen and the controller is integrated with the user interface such that the controller is mounted within the outer housing between the annular sidewall of the inner lining and the touch screen.

3. A cooking apparatus as in claim 1 further comprising a transceiver adapted for transmitting and receiving wireless data signals, wherein the transceiver is in electrical communication with the controller.

4. A cooking apparatus as in claim 1 further comprising an actuator in electrical communication with the controller and a lid;
the lid comprising a plurality of protrusions, a valve, and a valve release;
wherein the plurality of protrusions extend inward from an exterior circumference and are adapted to mate with the rim of the inner lining;
wherein, when the plurality of protrusions are mated with the rim of the inner lining, the valve release and actuator are aligned such that actuation of the actuator activates the valve release.

5. A cooking apparatus as in claim 4 wherein the user interface is disposed on includes a selectable input that, when selected, causes the controller to transmit a signal to the actuator to actuate, and actuation of the actuator activates the valve release to release pressure within the cavity; and
wherein user interface disposed on the annular wall of the outer housing such that it is located on the opposite side of the housing from the valve on the lid.

6. A cooking apparatus as in claim 4 wherein the controller is configured to control the operation of the cooking apparatus and when the cooking apparatus reaches a predetermined event, the controller automatically transmits a signal to the actuator to actuate and activate the valve release to release pressure within the cavity.

7. A cooking apparatus as in claim 6 wherein the controller is configured such that, upon reaching the predetermined event but before automatically transmitting the signal to the actuator, the controller transmits signals causing the display to display a countdown corresponding to the time at which the actuator will actuate.

8. A cooking apparatus as in claim 7 wherein simultaneously with the countdown, the controller is configured to transmit signals to a speaker causing the speaker to emit a series of noises with increasing frequency as the countdown approaches the time at which the actuator will actuate.

9. A cooking apparatus as in claim 7 wherein, the controller is configured such that it includes a normal mode and a silent mode, wherein when the controller is in normal mode, selecting one or more options through the user interface causes the controller to transmit a signal to the speaker to emit a noise; and
wherein when the controller is in silent more, selecting one or more options through the user interface will not cause the controller to transmit a signal to the speaker to emit a noise; and
when the controller is in silent mode, simultaneously with the countdown, the controller transmits signals to a speaker causing the speaker to emit a series of noises with increasing frequency as the countdown approaches the time at with the actuator will actuate.

10. A cooking apparatus as in claim 6 comprising a proximity sensor configured to sense the proximity of an object to the valve and transmit a proximity warning signal to the controller when an object is located proximal to the valve.

11. A cooking apparatus as in claim 10 wherein prior to sending a signal to the actuator to actuate, the controller is configured to check for the proximity warning signal and not automatically transmit a signal to the actuator to actuate when the controller is receiving the proximity warning signal.

12. A cooking apparatus as in claim 11 wherein the user interface includes a manual proximity override option such that selection of the manual proximity override option causes the controller to transmit a signal to actuate the actuator even when the proximity warning signal is being transmitted to the controller.

13. A cooking apparatus as in claim 4 wherein the lid includes a pressure sensor that provides a visual indication as to whether the cavity is pressurized.

14. A cooking apparatus as in claim 13 wherein the pressure sensor is a plunger that is a first color and raises above a portion of the lid surrounding the plunger when the cavity is pressurized and wherein the portion of the lid surrounding the plunger is a second color.

15. A cooking apparatus as in claim 1 wherein the user interface comprises a display screen and a selection knob each in electrical communication with the controller; wherein the controller is configured to display a menu of options and wherein turning the selection knob cycles through a plurality of the options to highlight one or more of the options and depressing the selection knob selects a highlighted option.

16. A cooking apparatus as in claim 1 wherein the options include a plurality of preset recipes corresponding to a plurality of ingredients, and wherein after a user selects an ingredient, the controller is configured to capture data transmitted from the plurality of pressure sensors, the data corresponding the pressure sensed by the pressure sensors; the controller is further configured to calculate a cooking time for the ingredient based on the ingredient selected, the pressure sensed, and a cooking method.

17. A cooking system comprising:
a user cooking device comprising a controller in electrical communication with a transceiver configured to send and receive wireless communication signals;
a user computer in electrical communication with a transceiver configured to send and receive wireless communication signals;
an internet connected remote computer having stored thereon a plurality of approved recipes;
wherein each approved recipe corresponds to a recipe for cooking food using the same model cooking device as the user cooking device and each recipe having been cooked using the same model cooking device as the user cooking device prior to the recipe being stored on the remote computer;
wherein the user cooking device and user computer are each wirelessly connected to the remote computer;
wherein the user computer sends control signals to the user cooking device through the remote computer and the user cooking device provides operational feedback data to the user computer through the remote computer.

18. A method of cooking food comprising:
accessing a recipe on a remote computer via a user computer wherein the recipe includes instructions for cooking food utilizing a specific model cooking device;
activating a cooking device corresponding to the specific model cooking device of the recipe;
displaying on the user device a first recipe step identifying a desired weight for an ingredient to be cooked;
placing the ingredient into the cooking device and the cooking device automatically transmitting the weight of the ingredient to the user computer;
displaying on the user computer an indication that the weight of the ingredient in the cooking device corresponds to the desired weight of the ingredient;
advancing the recipe on the user computer to a second step that instructs the user to add a second ingredient to the cooking device;
reaching the end of the recipe and the user device automatically transmitting a signal to cooking device to start cooking according to a time provided by the recipe and a cooking setting provided by the recipe;
the cooking device cooking the ingredients according to the time and cooking setting in response to receiving the signal to start cooking.
